(19) United States
(12) Patent Application Publication
(10) Pub. No.: US 2018/0321418 A1
(43) Pub. Date: Nov. 8, 2018

(54) ARTICLE INCLUDING A BODY INCLUDING A FLUORESCENT MATERIAL AND A WAVELENGTH SHIFTING FIBER, A RADIATION DETECTOR INCLUDING THE ARTICLE, AND A METHOD OF USING THE SAME

(71) Applicant: SAINT-GOBAIN CERAMICS & PLASTICS, INC., Worcester, MA (US)

(72) Inventors: Michael R. KUSNER, Auburn Township, OH (US); Peter R. MENGE, Novelty, OH (US)

(21) Appl. No.: 15/969,410

(22) Filed: May 2, 2018

Related U.S. Application Data
(60) Provisional application No. 62/503,124, filed on May 8, 2017.

(51) Int. Cl. G01V 5/00; G01T 1/20; G01T 1/28

(52) U.S. Cl. CPC G01V 5/0075; G01T 1/28; G01T 1/2006

(57) ABSTRACT

An article can include a body including a fluorescent material and a wavelength shifting fiber. In an embodiment, the fiber can have a cross-sectional dimension of at least 1.5 mm, and outer dimensions of the body define a volume of at least 5 liters. In another embodiment, the article can include wavelength shifting fibers organized in at least two rows and at least columns. In another aspect, a radiation detector can include a body including a fluorescent material; a wavelength shifting fiber having a cross-sectional area; and a photosensor including a light-receiving surface having a light-receiving area of at least 9 mm², wherein the cross-sectional area of the wavelength shifting fiber is at least 25% of the light-receiving area. The article and radiation detector are well suited for relatively large radiation detectors that have bodies with relatively short attenuation lengths.

### CROSS-REFERENCE TO RELATED APPLICATIONS

The present application claims priority under 35 U.S.C. § 119(e) to U.S. Provisional Patent Application No. 62/503,124, filed May 8, 2017, entitled “Article Including a Body Including a Fluorescent Material and a Wavelength Shifting Fiber, a Radiation Detector Including the Article, and a Method of Using the Same,” naming as inventors Michael R. Kusner et al., which is assigned to the current assignee hereof and is incorporated by reference herein in its entirety.

### FIELD OF THE DISCLOSURE

The present disclosure is directed to articles including bodies including a fluorescent material and wavelength shifting fibers, radiation detectors including the articles, and methods of detecting radiation using the same.

### BACKGROUND

Port-of-entry radiation detectors can be used to detect radiation within cargo or a vehicle. Many times, the cargo can be within a container used in a container ship, and the vehicle can be a truck. Thus, the volume to be monitored by the radiation detector can be very large. The cargo or vehicle may need to be monitored for radioactive materials. Designing a radiation detector for such an application can be quite challenging. Further improvements for such radiation detectors are desired.

### BRIEF DESCRIPTION OF THE DRAWINGS

Embodiments are illustrated by way of example and are not limited in the accompanying figures.

FIG. 1 includes an illustration of a radiation detection apparatus in accordance with an embodiment.

FIG. 2 includes an illustration of a perspective view of an article that includes a body and wavelength shifting fibers in accordance with an embodiment.

FIG. 3 includes an illustration of an end view of an article that includes a body and wavelength shifting fibers in accordance with another embodiment.

FIG. 4 includes an illustration of an end view of an article that includes a body and wavelength shifting fibers in accordance with still another embodiment.

FIG. 5 includes an illustration of a perspective view of an article that includes a body and wavelength shifting fibers in accordance with yet another embodiment.

FIG. 6 includes an illustration of a perspective view of an article that includes a body and wavelength shifting fibers in accordance with a further embodiment.

FIG. 7 includes a depiction of an article, photosensors coupled to wavelength shifting fibers, and an electronics module coupled to the photosensors.

FIG. 8 includes a depiction of exemplary components within an electronics module.

FIG. 9 includes a table that includes information regarding light collection efficiency for different attenuation lengths and configurations.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

Group numbers corresponding to columns within the Periodic Table of the elements use the “New Notation” convention as seen in the CRC Handbook of Chemistry and Physics, 81^{st} Edition (2000-2001).

The term “rare earth” or “rare earth element” is intended to mean Y, Sc, and the lanthanide elements (La to Lu) in the Periodic Table of the Elements.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

The articles and radiation detectors described herein are well suited for larger sizes of radiation detectors, such as those used to detect radiation in port-of-entry applications. An article can have a body with a radiation-sensitive material and optionally may include another material, wherein such material(s) may be at concentration such that the light attenuation length within the body is relatively short. Wavelength shifting fibers can increase light collection efficiency, particularly when the cross-sectional areas of the fibers are more closely matched to the light-receiving area of their corresponding photosensors. The wavelength shifting fibers can be embedded within the body or may be attached to the outer surfaces of the body.

An article can include a body including a fluorescent material, and a wavelength shifting fiber. In an embodiment, such fiber can have a cross-sectional dimension of at least 1.5 mm, and outer dimensions of the body define a volume of at least 5 liters. In another embodiment, the article can include wavelength shifting fibers organized in at least two rows and at least columns within the body. In a further embodiment, the body has a dimension of at least 2 cm and another dimension of at least 50 cm. The body has a light attenuation length of at most 50 cm and a corresponding light collection efficiency of at least 0.8%; a light attenuation length of at most 350 cm and a corresponding light collection efficiency of at least 4.3%; a light attenuation length of at most 1000 cm and a corresponding light collection efficiency of at least 11%; or any combination thereof.

In another aspect, a radiation detector includes the body, the wavelength shifting fiber, and a photosensor. The fiber has a cross-sectional area, and the photosensor includes a light-receiving surface having a light-receiving area of at least 9 mm2. The cross-sectional area of the wavelength shifting fiber can be at least 25% of the light-receiving area.

Embodiments described below and illustrated are provided to aid in understand the concepts as set forth herein. The embodiments are merely illustrative and not intended to limit the scope of the present invention, as set forth in the appended claims.

FIG. 1 illustrates a radiation detector 102 that can be used as a security inspection apparatus, such as one that may be used at a port of entry into a country. In FIG. 1, the radiation detector 102 is inspecting a vehicle 104, and more particularly, a truck. The radiation detector 102 has a relatively large volume, as it needs to inspect a large object. In another embodiment, cargo, such as a container from a container ship, a pallet of goods, or the like, humans, baggage, or other objects may be inspected. The size of a particular radiation detector can depend on what object is to be monitored for radioactive material. In an embodiment, the radiation detector 102 can have a height of at least 110 cm, at least 250 cm, at least 500 cm, or more. In another embodiment, the height may be at most 950 cm, as most cargo and vehicles have heights less than 950 cm. However, the height of the radiation detector 102 may be less than or greater than the values previously described.

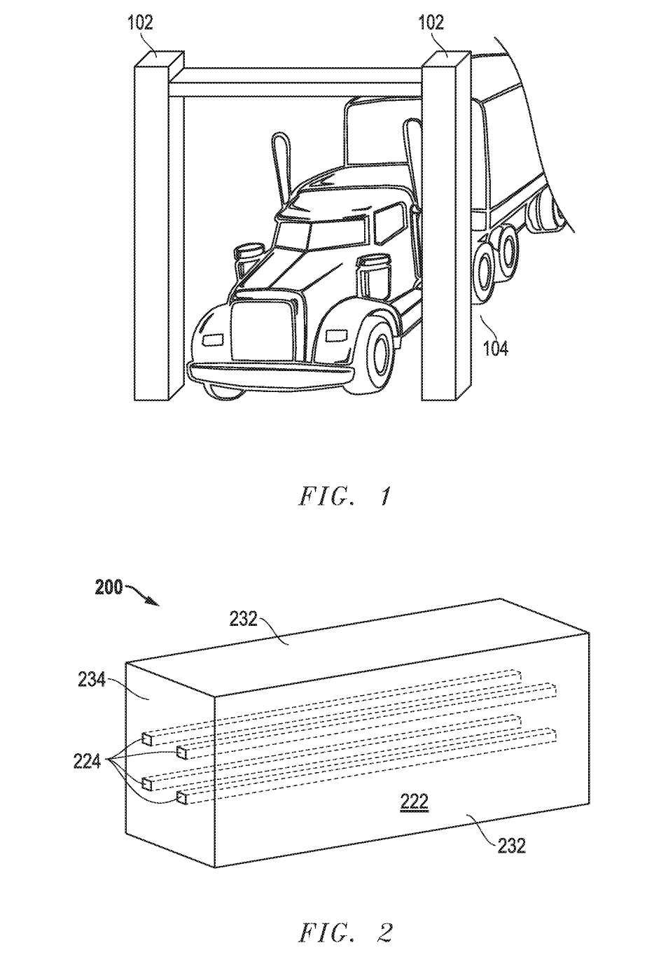

FIG. 2 includes a depiction of an article 200 that can be used within the radiation detector 102. The article 200 has a body 222 and wavelength shifting fibers 224. The body 222 can include a radiation sensitive material that is responsive to targeted radiation and a matrix material. The radiation-sensitive material can be selected to detect targeted radiation. The fluorescent material can be the radiation-sensitive material or may be another material that captures alpha or charged particles emitted by the radiation-sensitive material and emits scintillation light in response to excitation by the alpha or charged particles.

When the targeted radiation is gamma radiation, the radiation-sensitive material can include an appropriate metal halide, a silicate, a garnet, a perovskite, or the like, all of which are inorganic compounds that can be in the form of solid particles. In an embodiment, the solid particles may be at least 0.11 wt. %, at least 0.3 wt. %, or at least 0.5 wt. % of mass of the body 222. Such materials may convert gamma radiation energy to scintillation light. In a particular embodiment, the radiation-sensitive material can include an element with an atomic number greater than 38. The radiation-sensitive material may be a non-particulate metallo-organic such as allyl-triphenyltin or palladium pivalate.

In another embodiment, the radiation-sensitive material can include organic scintillation molecules. The organic scintillation molecules can include as p-terphenyl (C18H14), PBD (2-phenyl-5-(4-biphenyl)-1,3,4-oxadiazole, C20H14N2O), butyl PBD (2-(4-tert-Butylphenyl)-5-(4-biphenyl)-1,3,4-oxadiazole, C24H22N2O), PPO (2,5-diphenyloxazole, C15H11NO), or the like. In an embodiment, the organic scintillation molecules may be at least 0.11 wt. %, at least 0.5 wt. %, or at least 1.5 wt. % of the mass of the body 222, and in another embodiment organic scintillation molecules may be at most 40 wt. %, at most 35 wt. %, or at most 30 wt. % of the mass of the body 222. If needed or desired, the body 222 can include wavelength shifting molecules that can shift light to a longer wavelength. For example, PPO may emit ultraviolet light, and the wavelength shifting molecule can absorb the ultraviolet radiation and shift such light into the blue light (e.g., 400 nm to 450 nm) of the visible light spectrum.

When the targeted radiation is neutrons, the radiation-sensitive material can include 6Li, 10B, or Gd, in atomic form or as part of a compound. In a particular embodiment, the radiation-sensitive material can include LiF that may have a naturally occurring amount of 6Li or may be enriched to have more than 10% of all Li in the form of 6Li. Gamma rays, alpha or other charged particles emitted after a nuclear reaction with 6Li, 10B, or Gd can be captured by another material and emit scintillation light. In a particular embodiment, such other materials can include ZnS that may be doped with Ag or Cu. In a further embodiment, 6Li, 10B, or Gd or another high-Z atom (atomic number higher than 39) may be added in ligands to organic molecules.

In an embodiment, the body 222 can be monolithic. The matrix of the body 222 can include a polymer. The polymer can be relatively transmissive to scintillation light generated within the body 222. Thus, the polymer has a substantially lesser affect on the light attenuation length within the body 222, as compared to the radiation-sensitive and potentially other materials present within the body 222. In an embodiment, the polymer of the matrix can include a polyvinyltoluene, a polystyrene, a polymethylmethacrylate, polyvinycarbazole, another suitable polymer, or any co-polymer thereof.

As illustrated in FIG. 2, the body 222 has the shape of a cuboid. In another embodiment, a variety of different cuboid and other shapes may be used. Such other shapes can include a circular cylinder (having circular end surfaces), an elliptical cylinder (having elliptical end surfaces), an octahedron (e.g., an octahedron having hexagonal end surfaces), another polyhedron, or the like. In the embodiment illustrated, the body 222 has the shape of a rectangular cuboid. In embodiment, the area of each of the side surfaces 232 (two of which are identified in FIG. 2) of the body 222 may be substantially greater than each of the two end surfaces 234 (one of which is identified in FIG. 2) of the body 222. In a particular embodiment, the area of at least one of the side surfaces 232 may be an order of magnitude greater than each of the two end surfaces 234. The body 222 can have a length of at least 50 cm, at least 110 cm, or at least 250 cm. The body 222 can have another dimension, which along the end surfaces, that is at least 2 cm, at least 5 cm, or at least 11 cm.

The volume of the body 222 can depend on the size of the radiation detector 102. The volume of the body 222 as defined by the outer dimensions of the body 222, can be at least 5 liters, at least 11 liters, or at least 20 liters. In another embodiment, the volume of the body may be at most 900 liters, as most radiation detectors do not need larger volumes. However, the volume of the body 222 may be less than or greater than the values previously described.

The concentration of the radiation-sensitive material, and if present, a separate fluorescent material or wavelength shifting molecules within the body 222 can be present at a level that significantly reduces the attenuation length of light traveling within the body 222. As used in this specification, the attenuation length is the distance over which light generated within the body is reduced to 1/e (the base number corresponding to the natural logarithm, 1n) or approximately 36.8% of the light as originally generated. Many times, the attenuation length may be at most 1000 cm, at most 350 cm, or at most 50 cm. In some commercial applications, users may specify an attenuation length of at least 300 cm. However, in some applications, an attenuation length may be less than 95 cm due to the presence of opaque materials, such as solid particles, or light absorbing materials at relatively higher concentrations.

Detecting radiation can be challenging with the attenuation lengths, the shapes and volumes of the body 222 as previously described. To improve the detection of radiation, wavelength shifting fibers 224 can be embedded within the body 222. In an embodiment, the sides of the wavelength shifting fibers 224 are completely surrounded by body 222. Each of the end surfaces of the wavelength shifting fibers 224 can be optically coupled to a photosensor or a reflector. Thus, each wavelength shifting fiber can be coupled to one or two photosensors. The shapes of the wavelength shifting fibers 224 may be any of the shapes as previously described with respect to the shape of the body 222.

The lengths of the wavelength shifting fibers 224 can have any of the lengths as previously described with respect to the body 222. The lengths of the wavelength shifting fibers 224 may have lengths that are within 2 cm of the length of the body 222. In a particular embodiment, end surfaces of the wavelength shifting fibers 224 may be flush with one or both of end surfaces 234 of the body 222.

The dimensions along the end surfaces of the wavelength shifting fibers 224 may be significantly larger than wavelength shifting fibers as used in a radiation detector described in US 2011/0079726. A cross-sectional dimension, such as a width, diameter, a major or minor axis, or the like, can be at least 1.5 cm, at least 3 mm, at least 5 mm or even higher. As a point of comparison, a cross-sectional dimension of wavelength shifting fiber is typically no greater than 1 mm. The relatively larger cross-sectional dimension of the wavelength shifting fiber 224 allows for more light collection efficiency, as the cross-sectional area of the wavelength shifting fiber can be tailored more closely to the light-receiving area of its corresponding photosensor, as addressed later in this specification.

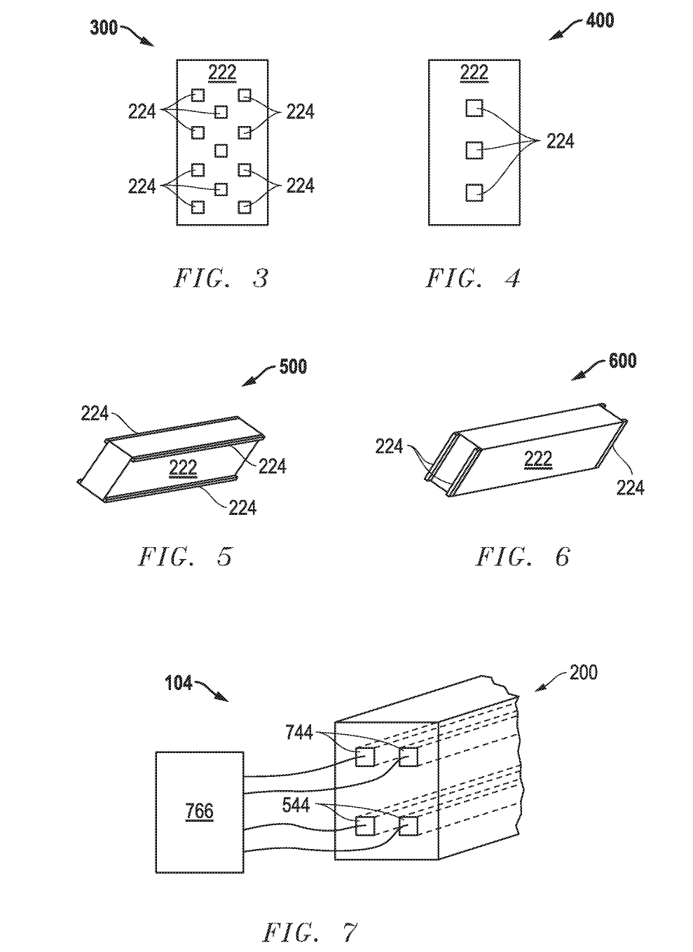

The number or organization of wavelength shifting fibers 224 within the article 200 can be tailored for a particular application and may depend at least in part on the attenuation length of the body 222. In an embodiment, the organization can include at least two rows and at least two columns. FIG. 2 illustrates the article 200 having four wavelength shifting fibers 224 organized into two rows and two columns. FIGS. 3 and 4 illustrate articles 300 and 400 that include different numbers and organizations of wavelength shifting fibers 224. The article 300 has more wavelength shifting fibers 224, and the article 400 has fewer wavelength shifting fibers 224. The article 300 has a diamond pattern of wavelength shifting fibers 224, and the article 400 has the wavelength shifting fibers 224 organized along a vector. Other numbers and organizations of wavelength shifting fibers 224 can be used. Thus, the number and organizations of the wavelength shifting fibers described and illustrated herein are merely exemplary and do not limit the scope of the present invention as defined in the appended claims.

Different methods can be used to form the articles 200, 300, and 400. With respect to the body 222, the materials for the matrix, radiation-sensing, and potentially other materials are combined. The body 222 can be formed by extrusion or by a polymeric reaction within a form. If needed or desired, a cutting, smoothing or other similar operation may be performed to achieve a desired shape for the body 222.

The wavelength shifting fibers 224 can be introduced at the time of formation of the body 222 or after the initial shape for the body 222 is formed. In a particular embodiment, the wavelength shifting fibers 224 can be co-extruded with the materials that make up the body 222. Thus, any of the articles 200, 300, and 400 can be formed by a co-extrusion process. In another embodiment, the body 222 can be cored, and the wavelength shifting fibers 224 can be inserted into the cored out portions of the body 222 to form any of articles 200, 300 and 400. In an embodiment, no adhesive is required between the body 222 and the wavelength shifting fibers 224. In another embodiment, only a few spots of adhesive may be used to keep the wavelength shifting fibers 224 from sliding out of the body 222.

In another embodiment, the wavelength shifting fibers may be at other locations within an article. In FIG. 5, an article 500 includes the body 200 and the wavelength shifting fibers 224, wherein the wavelength shifting fibers 224 are located at corners and extend in the same direction as the length of the body 200. In FIG. 6, the article 600 includes the body 200 and the wavelength shifting fibers 224, wherein the wavelength shifting fibers 224 are located at corners and extend in the a direction perpendicular to the length of the body 200. As compared to article 200, articles 500 and 600 may not perform as well; however, in particular geometries, articles 500 and 600 can perform better than an article that includes the body 222 without any wavelength shifting fibers.

The articles 500 and 600 can be formed using a co-extrusion process as previously described with respect to the articles 200, 300, and 400. Alternatively, the wavelength shifting fibers 224 can be placed adjacent to corners of the body 222. In an embodiment, a portion of the body 222 at or near a corner can be removed, and one of the wavelength shifting fibers 224 can be placed along the body where the portion has been cut out. In a further embodiment, the wavelength shifting fibers 224 can be placed along the outer surface of the body 222 without requiring the cut-out portion. If needed or desired, an adhesive may be used to attach the wavelength shifting fibers 224 to the body 200. The adhesive can be relatively transparent to the scintillation light, and an exemplary adhesive can include a silicone or acrylic adhesive.

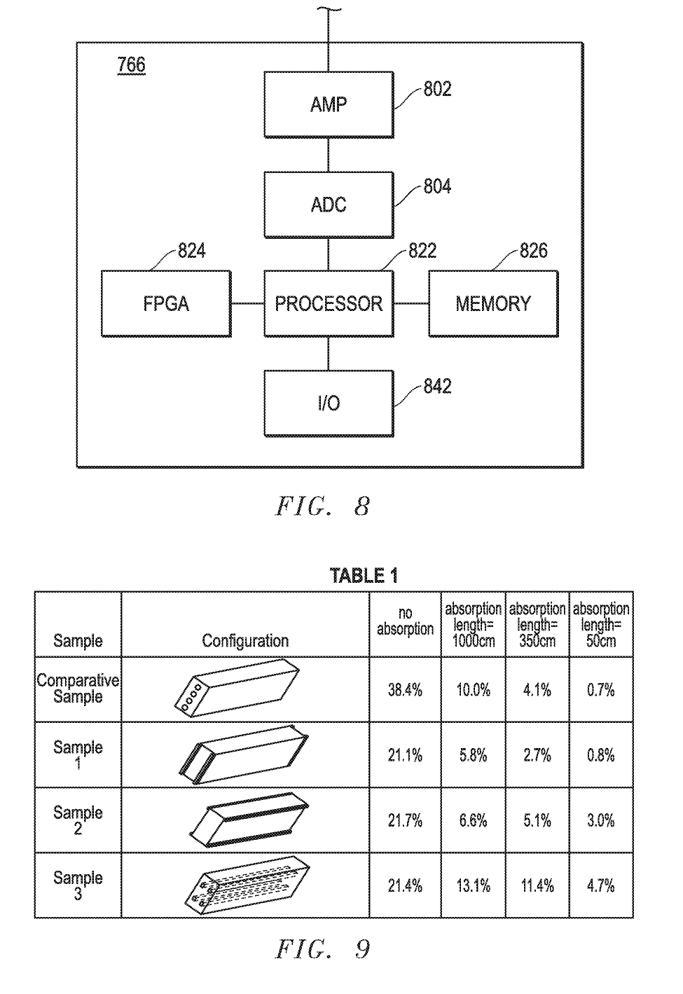

FIG. 7 illustrates a depiction in which photosensors 744 are optically coupled to the wavelength shifting fibers 224 and electrically coupled to an electronics module 766. In an embodiment, each photosensor 744 can be coupled to one wavelength shifting fiber. The photosensors 744 can be photomultiplier tubes (PMTs), semiconductor-based photomultipliers, avalanche photodiodes, hybrid photosensors, or a combination thereof. As used herein, a semiconductor-based photomultiplier in intended to mean a photomultiplier that includes a plurality of photodiodes, wherein each of the photodiodes have a cell size less than 1 mm, and the photodiodes are operated in Geiger mode. In practice, the semiconductor-based photomultiplier can include over a thousand photodiodes, wherein each photodiode has a cell size in a range of 10 microns to 100 microns and a fixed gain. The output of the semiconductor-based photomultiplier is the sum signal of all Geiger mode photodiodes. The semiconductor-based photomultiplier can include silicon photomultiplier (SiPM) or a photomultiplier based on another semiconductor material. For a higher temperature application (e.g., higher than 125° C.), the other semiconductor material can have a wider bandgap energy than silicon. An exemplary material can include SiC, a Ga-Group V compound (e.g., GaN, GaP, Ga2O3, or GaAs), or the like. An avalanche photodiode has a larger size, such as a light-receiving area of least 1 mm2 and is operated in a proportional mode.

In an embodiment, the cross-sectional area of the wavelength shifting fibers 224 and light-receiving area of its corresponding photosensor 744 can be selected so provide a better match between the areas. The better match allows for a higher light collection efficiency of scintillation light generated within the body. The higher light collection efficiency can allow for a faster and more accurate detection of radiation, a radiation source corresponding to the scintillation light, or both. In a particular embodiment, the cross sectional areas of the ends of the wavelength shifting fibers adjacent to the light-receiving surfaces of the photosensors 744 are at least 25%, at least 40%, at least 55%, or at least 65% of the light-receiving areas of their corresponding photosensors 744. In another embodiment, the cross-sectional areas of the wavelength shifting fibers 224 are at most 120% of the light-receiving areas of their corresponding photosensors. In an embodiment, the light-receiving area of the photosensor 744 can be less than a PMT. In a particular embodiment, the photosensors includes a set of photosensors that lie along a particular surface of the body, wherein a ratio of light-receiving area-to-fluorescent material volume is at most 5×10-5/cm, at most 2×10-5/cm, or at most 1×10-5/cm. In another particular embodiment, each photosensor has a light-receiving surface having a light-receiving area that is less than 500 mm2, less than 200 mm2, or less than 95 mm2. In a non-limiting example, a light-receiving surface of a photosensor can have light-receiving area of 3×3 mm2 (9 mm2), 4×4 mm2 (16 mm2), 5×5 mm2 (25 mm2), or 6×6 mm2 (36 mm2). In another embodiment, the light-receiving area is not square and may be circular, have different side dimensions, or another shape. The light-receiving surface can be coupled to an end of a wavelength shifting fiber 224 having any of the sizes and shapes previously described with respect to the light-receiving surfaces of the photosensor. The light-receiving surface of the photosensor and the end of the wavelength shifting fiber may have the same or different shapes. The light-receiving area of the photosensor and the area of the end of the wavelength shifting fiber may the same or different.

The photosensors 744 can receive the scintillation light and generate electronic pulses that are sent to the electronics module 766. Electronic pulses from the photosensors 744 can be shaped, digitized, analyzed, or any combination thereof by the electronics module 766. FIG. 8 includes a schematic diagram of an illustrative, non-limiting embodiment of the electronics module 766. As illustrated, an amplifier 802 is configured to receive an electronic pulse and is coupled to an analog-to-digital converter (“ADC”) 804, which is coupled to a processor 822. In an embodiment, the amplifier 802 can be a high fidelity amplifier. The processor 822 can be coupled to a programmable/re-programmable processing module (“PRPM”), such as a field programmable gate array (“FPGA”) 824 or application-specific integrated circuit (“ASIC”), a memory 826, and an input/output (“I/O”) module 842. The couplings may be unidirectional or bidirectional. The functions provided by the components are discussed in more detail below. A logic element can include the processor 822, the FPGA 824, ASIC, another suitable component configured to perform logic or computational operation, or any combination thereof. In another embodiment, more, fewer, or different components can be used in the electronics module 800. For example, functions provided by the FPGA 824 may be performed by the processor 822, and thus, the FPGA 824 is not required. The FPGA 824 can act on information faster than the processor 822.

A method of using a radiation detector is described with respect to the vehicle 104 and the radiation detector 102 in FIG. 1 that includes the article 200 in FIG. 2 and other components as illustrated in FIGS. 7 and 8. As the vehicle 104 passes by the radiation detector 102, the radiation detector 102 may receive radiation emitted from a radiation source within the vehicle 104. The radiation detector 102 may be configured for one or more types of targeted radiation. For example, the radiation detector 102 may be configured to detect neutrons, gamma radiation, x-rays, charged particles (e.g., alpha or beta particles), another type of radiation, or a combination thereof. In a particular embodiment, the radiation detector 102 is a dual-mode detector that can detect neutrons and gamma radiation. Fast neutrons can be converted to thermal neutrons by a neutron moderator (not illustrated) surrounding the body 222. Within the body 222, thermal neutrons can be captured by a neutron-sensitive material and emit charged particles, such as alpha particles. The charged particles deposit their energy in the body 222 to emit scintillation light. For gamma radiation, gamma radiation from the vehicle 104 can be received by the radiation detector 102 and enter the body 222. Within the body 222, gamma radiation can be converted to electrons by a gamma-radiation-sensitive material and emit scintillation light that may be different from the scintillation light when neutrons are captured. Scintillation light, whether directly or indirectly following the capture of thermal neutrons or gamma radiation, travels within the body and reaches the wavelength shifting fibers 224. The wavelength shifting fibers 224 absorb the scintillation light and re-emit light of a longer wavelength and transmit the light of the longer wavelength to the photosensors 744. The photosensors 744 generate electronic pulses in response to receiving the light of the longer wavelength. The electronic pulse is transmitted from the photosensors 744 to the electronics module 766.

The electronics module 766 performs a variety of functions, some of which may be specific to a particular application. Below are some exemplary functions that illustrate, and not limit, functions that can be performed downstream of the photosensors 744. The electronic pulse, which is an analog signal, can be amplified by amplifier 802, and the amplified analog signal can be converter to a digital signal in the ADC 804. The digital signal is transmitted from the ADC 804 to the processor 822, which can operate on instructions provided by the memory 826 or received from an external source, such as a computer, via the I/O module 842. The processor 822 can analyze the digital signal and determine whether the captured radiation corresponds to a neutron or gamma radiation, and potentially determine the radiation source, such as 60Co, 137Cs, 241Am, 240Pu or the like. A filter, such as to remove background noise, or a correction factor, such as one to correct for a temperature difference between the temperatures at (1) the time of detection of the vehicle 102 and (2) the time of calibration, or the like may be used if needed or desired. Some of the functions described with respect to the processor 822 may be performed by the FPGA 824 or by an external computer via the I/O module 842. The digital signal, information derived from the digital signal, or the like may be stored in the memory 826 or may be transmitted from the radiation detector 102 via the I/O module 842.

The concepts as described in this specification are not limited to the particular application previously described. The radiation detector 102 can be configured for another type of radiation. In another application, the electronic module 766 may not be part of the radiation detector 102 and may be location remotely away from the article 102 and the photosensors 744. After reading this specification, skilled artisans will be able to determine a particular configuration to detect radiation using any of the articles described herein and photosensors.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiment 1

An article including a body including a fluorescent material, wherein the body is monolithic; and a first wavelength shifting fiber having a cross-sectional dimension of at least 1.5 mm, wherein outer dimensions of the body define a volume of at least 5 liters.

### Embodiment 2

An article including a body including a fluorescent material, wherein the body is monolithic; and wavelength shifting fibers organized in at least two rows and at least columns within the body, wherein the wavelength shifting fibers includes a first wavelength shifting fiber.

### Embodiment 3

An article including a body including a fluorescent material and having a first dimension of at least 2 cm and another dimension of at least 50 cm, wherein the body has: an attenuation length of at most 50 cm and a corresponding light collection efficiency of at least 0.8%; an attenuation length of at most 350 cm and a corresponding light collection efficiency of at least 4.3%; an attenuation length of at most 1000 cm and a corresponding light collection efficiency of at least 11%; or any combination thereof.

### Embodiment 4

The article of Embodiment 3, further including a first wavelength shifting fiber.

### Embodiment 5

A radiation detector including a body including a fluorescent material; a first wavelength shifting fiber having a first cross-sectional area; and a first photosensor including a light-receiving surface having a first light-receiving area of at least 9 mm2, wherein the first cross-sectional area of the first wavelength shifting fiber is at least 25% of the first light-receiving area.

### Embodiment 6

The radiation detector of Embodiment 5, wherein the first cross-sectional area of the first wavelength shifting fiber is at least 40%, at least 55%, or at least 65% of the first light-receiving area.

### Embodiment 7

The radiation detector of Embodiment 5 or 6, wherein the first photosensor is a solid-state photosensor.

### Embodiment 8

The radiation detector of any one of Embodiments 5 to 7, wherein the radiation detector includes photosensors, including the first photosensor, and wavelength shifting fibers, including the first wavelength shifting fiber.

### Embodiment 9

The radiation detector of Embodiment 8, wherein each photosensor having a light-receiving area that is less than 500 mm2, less than 200 mm2, or less than 95 mm2.

### Embodiment 10

The radiation detector of Embodiment 8 or 9, wherein the photosensors includes a set of photosensors that lie along a particular surface of the body, wherein a ratio of light-receiving area-to-volume of the body is at most 5×10-5/cm, at most 2×10-5/cm, or at most 1×10-5/cm.

### Embodiment 11

The radiation detector of any one of Embodiments 8 to 10, wherein each photosensor is optically coupled to one wavelength shifting fiber.

### Embodiment 12

The radiation detector of any one of Embodiments 8 to 11, wherein each wavelength shifting fiber is optically coupled to one or two photosensors.

### Embodiment 13

The radiation detector of Embodiment 12, wherein the photosensors further includes a second photosensor, and the first wavelength shifting fiber is optically coupled to the first photosensor along one end of the first wavelength shifting fiber and optically coupled to the second photosensor along an opposite end of the first wavelength shifting fiber.

### Embodiment 14

The radiation detector of any one of Embodiments 5 to 13, wherein the first wavelength shifting fiber is optically coupled to the first photosensor along one end of the first wavelength shifting fiber and a reflector lies along an opposite end of the first wavelength shifting fiber.

### Embodiment 15

The radiation detector of any one of Embodiments 5 to 14, further including an electronics module coupled to the first photosensor.

### Embodiment 16

The radiation detector of Embodiment 15, wherein the electronics module is configured to identify a source of radiation in response to the radiation captured by the body.

### Embodiment 17

The article or the radiation detector of any one of Embodiments 1 to 16, wherein the first wavelength shifting fiber having a cross-sectional dimension of at least 1.5 mm, at least 3 mm, at least 4 mm, or at least 5 mm.

### Embodiment 18

The article or the radiation detector of any one of Embodiments 1 to 17, wherein the outer dimensions of the body define a volume of at least 5 liters, at least 11 liters, or at least 20 liters.

### Embodiment 19

The article or the radiation detector of any one of Embodiments 1 and 3 to 18, wherein the article includes wavelength shifting fibers, including the first wavelength shifting fiber; and the wavelength shifting fibers organized in at least two rows and at least columns within the body, wherein the wavelength shifting fibers includes a first wavelength shifting fiber.

### Embodiment 20

The article or the radiation detector of any one of Embodiments 1, 2, and 5 to 19, wherein the body has a first dimension of at least 2 cm and a second dimension of at least 50 cm and: an attenuation length of at most 50 cm and a corresponding light collection efficiency of at least 0.8%, at least 2%, at least 3%, or at least 4%; an attenuation length of at most 350 cm and a corresponding light collection efficiency of at least 4.3%, at least 5.0%, or at least 10.5%; an attenuation length of at most 1000 cm and a corresponding light collection efficiency of at least 11%, at least 12%, or at least 13%; or any combination thereof.

### Embodiment 21

The article or the radiation detector of any one of Embodiments 1 to 20, wherein the body includes a polymer matrix.

### Embodiment 22

The article or the radiation detector of any one of Embodiments 1 to 21, wherein the body includes a polyvinyltoluene, a polystyrene, a polymethylmethacrylate, polyvinycarbazole, or any co-polymer of the foregoing.

### Embodiment 23

The article or the radiation detector of any one of Embodiments 1 to 22, wherein the fluorescent material includes solid particles.

### Embodiment 24

The article or the radiation detector of any one of Embodiments 1 to 23, wherein the body further includes a neutron-sensing material that includes solid particles.

### Embodiment 25

The article or the radiation detector of any one of Embodiments 1 to 24, wherein the body further includes 6Li, 10B, or Gd.

### Embodiment 26

The article or the radiation detector of any one of Embodiments 1 to 25, wherein the body further includes an element with an atomic number greater than 38.

### Embodiment 27

The article or the radiation detector of any one of Embodiments 24 to 26, wherein the solid particles are at least 0.11 wt. %, at least 0.3 wt. %, or at least 0.5 wt. % of a mass of the body.

### Embodiment 28

The article or the radiation detector of any one of Embodiments 1 to 27, wherein the fluorescent material includes organic scintillation molecules.

### Embodiment 29

The article or radiation detector of Embodiment 28, wherein the organic scintillation molecules include as p-terphenyl (C18H14), PBD (2-phenyl-5-(4-biphenyl)-1,3,4-oxadiazole, C20H14N2O), butyl PBD (2-(4-tert-Butylphenyl)-5-(4-biphenyl)-1,3,4-oxadiazole, C24H22N2O), or PPO (2,5-diphenyloxazole, C15H11NO).

### Embodiment 30

The article or the radiation detector of Embodiment 28 or 29, wherein the wavelength-shifting fiber includes bis-MSB (p-bis-(o-methylstyryl)-benzene, C24H22), TPB (1,1,4,4-tetraphenyl butadiene, C28,H22), or DPS (p,p′-diphenyl stilbene, C26H22).

### Embodiment 31

The article or the radiation detector of any one of Embodiments 28 to 30, wherein the organic scintillation molecules are 0.11 wt. %, at least 0.5 wt. %, or at least 1.5 wt. % of the body.

### Embodiment 32

A method of detecting a radioactive material, the method including providing the article or the radiation detector of any one of Embodiments 1 to 31; and scanning a vehicles or a cargo for a radioactive material using the article or the radiation detector.

### Example

The example demonstrates how wavelength shifting fibers and their positions can affect light collection efficiency. The example is not intended to limit the scope of the present invention, as defined in the appended claims.

A computer simulation was performed for four different samples (articles) that include polyvinyltoluene (PVT) as a matrix material with different attenuation lengths. FIG. 9 includes a table with information used and generated from the computer simulation. The different attenuation lengths correspond to different loadings (concentrations) of other materials dispersed within the body. For all of the samples, the body is in the shape of a rectangular cuboid having outer dimensions of 5.7×36×178 cm3 (2¼×14×70 in3) and corresponds to a volume of 36.1 liters. Comparative Example has an article that includes the body and does not have any wavelength shifting fibers within or attached to the body. Referring briefly to Table 1 (in the figures), Sample 1 has four wavelength shifting fibers along the shorter edges of the body, Sample 2 has four wavelength shifting fibers along the longer edges of the body, and Sample 3 has four wavelength shifting fibers equally spaced within the bulk of the body. The light receiving surfaces of the wavelength shifting fibers are optically coupled to SiPMs. The SiPMs for Samples 1 to 3 are not illustrated in the Table.

The photosensor configuration is different between the Comparative Sample and the other Samples. The Comparative Sample has four PMTs oriented along a line on an end of the body, where each PMT has a light-receiving surface of 28.6 mm (1⅛ in.) diameter that corresponds to a light-receiving area of 641 mm2. Samples 1 to 3 have a SiPM coupled to an end of each wavelength shifting fiber. Each SiPM has a light-receiving surface of 6×6 mm2 (36 mm2), and each SiPM has a light-receiving area of 6×6 mm2 (36 mm2). Thus, the total light-receiving area of the PMTs in the Comparative Sample is over an order of magnitude greater than the total light-receiving area of the SiPMs in Samples 1 to 3.

The wavelength of the scintillation light used for the simulation is 420 nm. Comparison Sample 1 has PMTs with quantum efficiencies better matched for the wavelength of scintillation light, as compared to the SiPMs. The wavelength shifting fibers shift the scintillation light to 500 nm. Samples 1 to 3 have SiPMs with quantum efficiencies better matched for the wavelength of the shifted light, as compared to the PMTs.

For the Comparative Sample and Samples 1 to 3, all surfaces of the bodies not covered by the PMTs or SiPMs were covered by a polytetrafluoroethylene (“PTFE”) reflector.

Table 1 in FIG. 9 includes light collection efficiency at different attenuation lengths. “No Attenuation” reflects a body that includes PVT and no other materials. Thus, most of the light loss is attributed to light that is absorbed by the PTFE before reaching a photosensor. Attenuation lengths of 1000 cm, 350 cm, and 50 cm correspond to higher loadings of other materials within the PVT.

For No Attenuation, the Comparative Sample has a light collection efficiency of 38.4%, and Samples 1 to 3 have a light collection efficiency in a range of 21.1% to 21.7%. The higher light collection efficiency for the Comparative Sample may be attributed to the substantially larger light-receiving area of the PMTs.

At an attenuation length of 1000 cm, light collection efficiency decreases for all of the samples. The light collection efficiency of the Comparative Example decreases to 10.0%, which is about 0.26 times the light efficiency of the Comparative Example at No Attenuation. Sample 1 has a light collection efficiency of 5.8%, which is about 0.27 times the light efficiency of the Sample 1 at No Attenuation. Thus, the light collection efficiency of Sample 1 decreases by a slightly smaller fractional amount, as compared to the Comparative Sample when going from No Attenuation to an attenuation length of 1000 cm. Sample 2 has a light collection efficiency 6.6%, which is about 0.30 times the light efficiency of the Sample 2 at No Attenuation. Thus, the light collection efficiency of Sample 2 decreases by a smaller fractional amount, as compared to the Comparative Sample when going from No Attenuation to an attenuation length of 1000 cm. Sample 3 is superior to all other samples at an attenuation length of 1000 cm, as it has the highest light collection efficiency. Sample 3 has a light collection efficiency of 13.1%, which is about 0.61 times the light efficiency of the Sample 3 at No Attenuation. Thus, the light collection efficiency of Sample 3 decreases by a smaller fractional amount, as compared to the Comparative Sample when going from No Attenuation to an attenuation length of 1000 cm.

At an attenuation length of 350 cm, light collection efficiency decreases for all of the samples. The Comparative Example decreases to 4.1%, which is about 0.11 times the light efficiency of the Comparative Example at No Attenuation. Sample 1 has a light collection efficiency of 2.7%, which is about 0.13 times the light efficiency of the Sample 1 at No Attenuation. Thus, the light collection efficiency of Sample 1 decreases by a smaller fractional amount, as compared to the Comparative Sample when going from No Attenuation to an attenuation length of 350 cm. Sample 2 is superior to the Comparative Example at an attenuation length of 350 cm. Sample 2 has a light collection efficiency of 5.1%, which is about 0.24 times the light efficiency of the Sample 2 at No Attenuation. Thus, the light collection efficiency of Sample 2 decreases by a smaller fractional amount, as compared to the Comparative Sample when going from No Attenuation to an attenuation length of 350 cm. Sample 3 is superior to all other samples at an attenuation length of 350 cm, as it has the highest light collection efficiency. Sample 3 has a light collection efficiency of 11.4%, which is about 0.53 times the light efficiency of the Sample 3 at No Attenuation. Thus, the light collection efficiency of Sample 3 decreases by a smaller fractional amount, as compared to the Comparative Sample when going from No Attenuation to an attenuation length of 350 cm.

At an attenuation length of 50 cm, light collection efficiency decreases for all of the samples. The Comparative Example decreases to 0.7%, and Sample 1 decreases to 0.8%. Such low light collection efficiencies may make the Comparative Example and Sample 1 poor candidates for use at an attenuation length of 50 cm. Sample 2 is superior to the Comparative Example at an attenuation length of 50 cm. Sample 2 has a light collection efficiency of 3.0%, which is about 0.14 times the light efficiency of the Sample 2 at No Attenuation. Thus, the light collection efficiency of Sample 2 decreases by a smaller fractional amount, as compared to the Comparative Sample when going from No Attenuation to an attenuation length of 50 cm. Sample 3 is superior to all other samples at an attenuation length of 50 cm, as it has the highest light collection efficiency. Sample 3 has a light collection efficiency of 4.7%, which is about 0.22 times the light efficiency of the Sample 3 at No Attenuation. Thus, the light collection efficiency of Sample 3 decreases by a smaller fractional amount, as compared to the Comparative Sample when going from No Attenuation to an attenuation length of 50 cm.

Of the four samples, Sample 3 can operate over a larger range of attenuation lengths and is significantly better than the Comparative Example at attenuation lengths of 50 cm to 1000 cm. Sample 2 is significantly better than the Comparative Example at attenuation lengths of 50 cm to 350 cm. As compared to Sample 3, Sample 2 may be easier to fabricate. Thus, Sample 2 may be a good alternative when fabrication complexity needs to be kept relatively low. Sample 1 did not perform better than the Comparative Example. However, if the body is shorter, for example 50 cm to 90 cm long, Sample 1 may perform better than the Comparative Sample at attenuation lengths in a range of 50 cm to 350 cm. If the attenuation length is shorter than 50 cm, more wavelength shifting fibers may be added to Samples 2 and 3.

Embodiments as described in this specification can allow for relatively large radiation detectors that can be used for inspecting cargo, vehicles, or other large objects. Concentrations of radiation-sensitive and possible other materials within a body may be at levels that significantly reduce attenuation length of scintillation light generated within the body. The wavelength shifting fibers can be embedded within the body or attached to the body. With respect to embedded wavelength shifting fibers, such fibers can be placed within the body at locations to achieve an acceptable light collection efficiency even as the attenuation length becomes relatively short, such as less than 350 cm, 50 cm, or even shorter. As an alternative, wavelength shifting fibers may be placed along the outside of a body. Such an alternative may provide a significantly easier to fabricate detector, particularly when the smallest dimension of the body is not too large, for example, no greater than two times the attenuation length of the body.

The wavelength shifting fibers having relatively larger cross-sectional areas, as compared to pancake-style radiation detectors, help increase light collection efficiency. The relatively larger wavelength shifting fibers can have cross-sectional areas that are tailored to match more closely the light-receiving areas of their corresponding photosensors. In a particular embodiment, semiconductor-based photomultipliers (e.g., SiPMs) are well suited for the relatively large radiation detectors. Better signal-to-noise ratio can be obtained as the cross-sectional area of the wavelength shifting fibers and light-receiving surfaces of the semiconductor-base photomultipliers are more closely matched. Thus, faster and more accurate detection of radiation can occur.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An article comprising:
a body including a fluorescent material, wherein the body is monolithic; and
a first wavelength shifting fiber having a cross-sectional dimension of at least 1.5 mm,
wherein outer dimensions of the body define a volume of at least 5 liters.

2. The article of claim 1, wherein the outer dimensions of the body define the volume of at least 11 liters.

3. The article of claim 1, wherein the body comprises:
a first dimension of at least 2 cm;
a second dimension of at least 50 cm;
an attenuation length of at most 1000 cm; and
a corresponding light collection efficiency of at least 0.8%.

4. The article of claim 1, wherein the fluorescent material comprises organic scintillation molecules.

5. The article of claim 4, wherein the organic scintillation molecules comprises 0.11 wt. % of a mass of the body.

6. The article claim 1, wherein the first wavelength shifting fiber having a cross-sectional dimension of at least 3 mm.

7. The article of claim 1, wherein the body comprises:
a first dimension of at least 2 cm;
a second dimension of at least 50 cm;
an attenuation length of at most 350 cm; and
a corresponding light collection efficiency of at least 3%.

8. The article of claim 1, wherein the body further comprises ⁶Li, ¹⁰B, or Gd.

9. The article of claim 1, further comprising a second wavelength shifting fiber, wherein the second wavelength shifting fiber comprises a cross-sectional dimension of at least 4 mm.

10. A radiation detector comprising:
a body comprising a fluorescent material;
at least two wavelength shifting fibers, wherein a first wavelength shifting fiber has a first cross-sectional area; and
at least two photosensors, wherein a first photosensor comprises a light-receiving surface having a first light-receiving area of at least 9 mm², wherein the first cross-sectional area of the first wavelength shifting fiber is at least 25% of the first light-receiving area.

11. The radiation detector of claim 10, wherein the first cross-sectional area of the first wavelength shifting fiber is at least 40% of the first light-receiving area.

12. The radiation detector of claim 10, wherein each of the at least two photosensors is optically coupled to at least one wavelength shifting fiber.

13. The radiation detector of claim 12, wherein each wavelength shifting fiber is optically coupled to two photosensors.

14. The radiation detector of claim 10, wherein the first wavelength shifting fiber comprises a cross-sectional dimension of at least 5 mm.

15. The radiation detector of claim 10, further comprising a second wavelength shifting fiber and wherein the second wavelength shifting fiber comprises a cross-sectional dimension of at least 5 mm.

16. The radiation detector of claim 10, wherein the body comprises:
a first dimension of at least 2 cm;
a second dimension of at least 50 cm;
an attenuation length of at most 1000 cm; and
a corresponding light collection efficiency of at least 0.8%.

17. The radiation detector of claim 10, wherein the fluorescent material comprises solid particles.

18. The radiation detector of claim 10, wherein the body further comprises ⁶Li, ¹⁰B, or Gd.

19. The radiation detector of claim 16, wherein the solid particles are at least 0.11 wt. % of a mass of the body.

20. A method of detecting a radioactive material, the method comprising:
scanning a vehicles or a cargo for a radioactive material using an article, the article comprising:
a body including a fluorescent material, wherein the body is monolithic; and
a first wavelength shifting fiber having a cross-sectional dimension of at least 1.5 mm, wherein outer dimensions of the body define a volume of at least 5 liters.
